(19) United States
(12) Patent Application Publication
(10) Pub. No.: US 2009/0242146 A1
(43) Pub. Date: Oct. 1, 2009

(54) MODULAR DRUM

(75) Inventors: Antonello La Marca, Corbas (FR); Anne-Sophie Panseri, Montanay (FR); Romain Simon, Lyon (FR)

Correspondence Address: YOUNG & THOMPSON, 209 Madison Street, Suite 500, ALEXANDRIA, VA, 22314, US

(73) Assignee: MAVIFLEX, Decines Charpieu (FR)

(21) Appl. No.: 12/139,626

(22) Filed: Jun. 16, 2008

Related U.S. Application Data
(60) Provisional application No. 60/935,264, filed on Aug. 2, 2007.

(30) Foreign Application Priority Data
Jun. 15, 2007 (FR) 07/04280

(51) Int. Cl. E06B 9/17; A44B 18/00

(52) U.S. Cl. 160/323.1; 24/442

(57) ABSTRACT

The modular drum according to the present invention consists of a central tubular profile (7a) made of steel or of a composite having in cross section a square or rectangular profile forming the central part or core of the said drive drum (7) and a demountable flexible shell (7m) having an external profile (7d) in the form of a portion of a cylinder and a flat and rectilinear internal profile (7e) complementary to that of the tubular profile (7a) so that the said drive drum (7) has a cylindrical external profile that can be deformed elastically under external pressure.

The present invention relates to a modular drum for a goods-handling door allowing a flexible apron or hauling straps to be wound up or unwound.

Goods-handling doors generally consist of vertical uprights joined together at their top by a drum which is driven, rotating it about its axis, by a motor secured to the structure of the door.

Rotating the drum about its axis allows a flexible apron or screen to be unwound and/or wound up either directly or via hauling straps connected to this flexible apron or screen, between an open position and a closed position.

The object of the present invention is to design a modular drive drum which has a structure allowing either the flexible apron or screen or the hauling straps depending on the features of the goods-handling door, to be wound up or unwound quietly.

The modular drum according to the present invention consists of a central tubular profile made of steel or of a composite having in cross section a square or rectangular profile forming the central part or core of the said drive drum and a demountable flexible shell having an external profile in the form of a portion of a cylinder and an internal profile complementary to that of the tubular profile so that the said drive drum has a cylindrical external profile that can be deformed elastically under external pressure.

The modular drum according to the present invention has other essential features which are described and protected in the subsidiary claims which are dependent either directly or indirectly on the main claim.

The attached drawings, which are given by way of example, will allow a better understanding of the invention, and its features and the advantages it is able to afford:

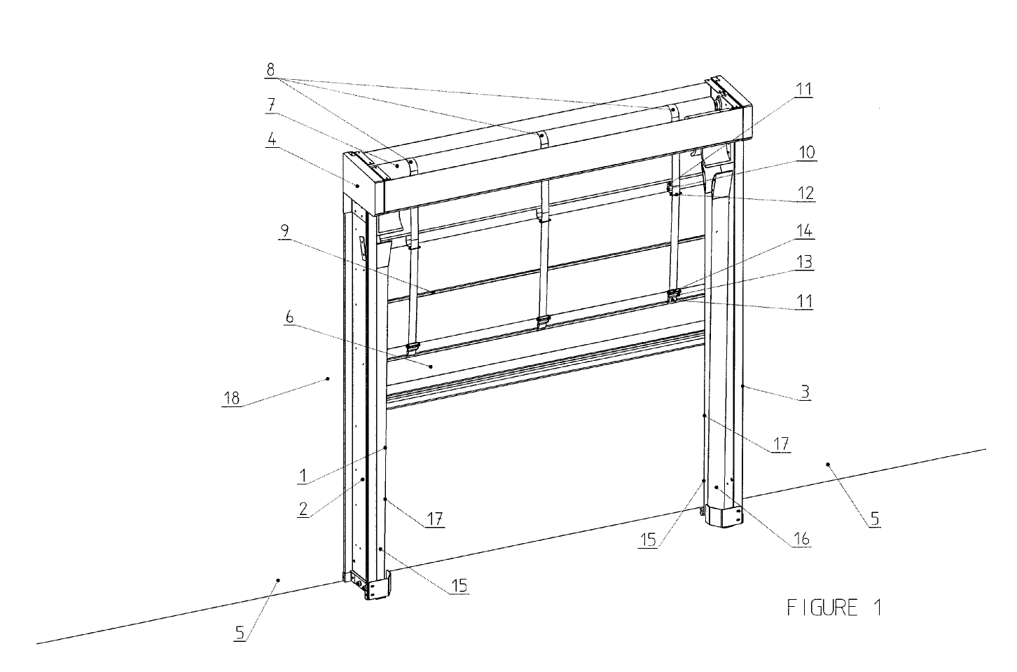

FIG. 1 is a perspective view illustrating one example of a goods-handling door equipped with a modular drum according to the present invention.

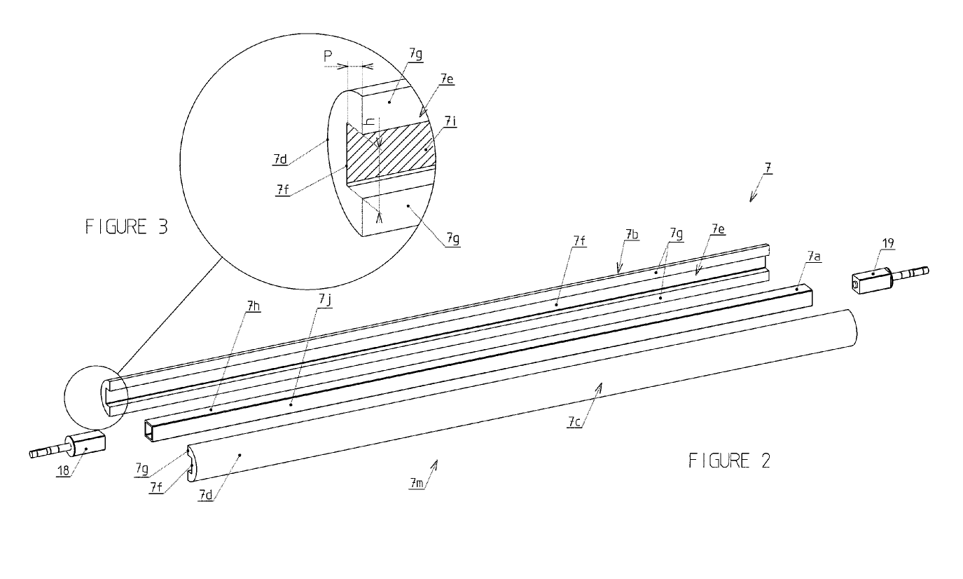

FIGS. 2 and 3 are perspective views illustrating a modular drum for driving a flexible apron or screen of a goods-handling door according to the present invention.

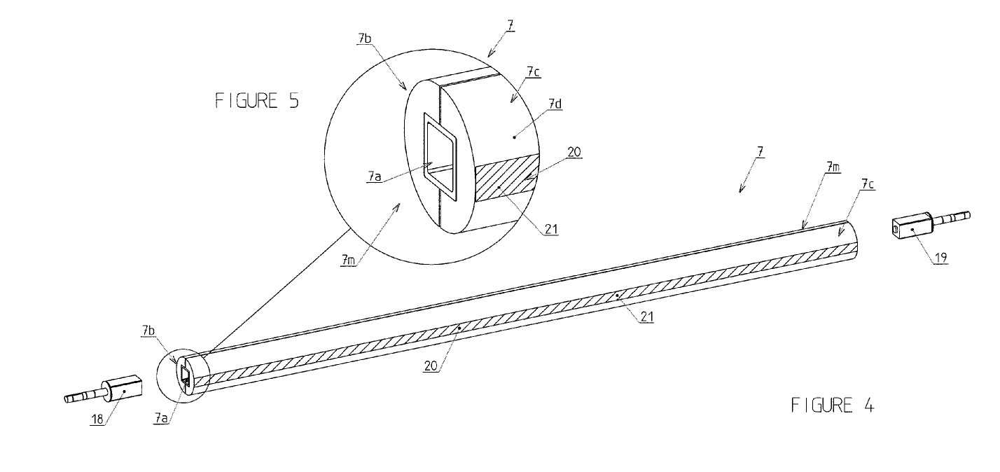

FIGS. 4 and 5 are perspective views showing the fixing of the flexible apron or screen of a goods-handling door to the modular drum according to the present invention.

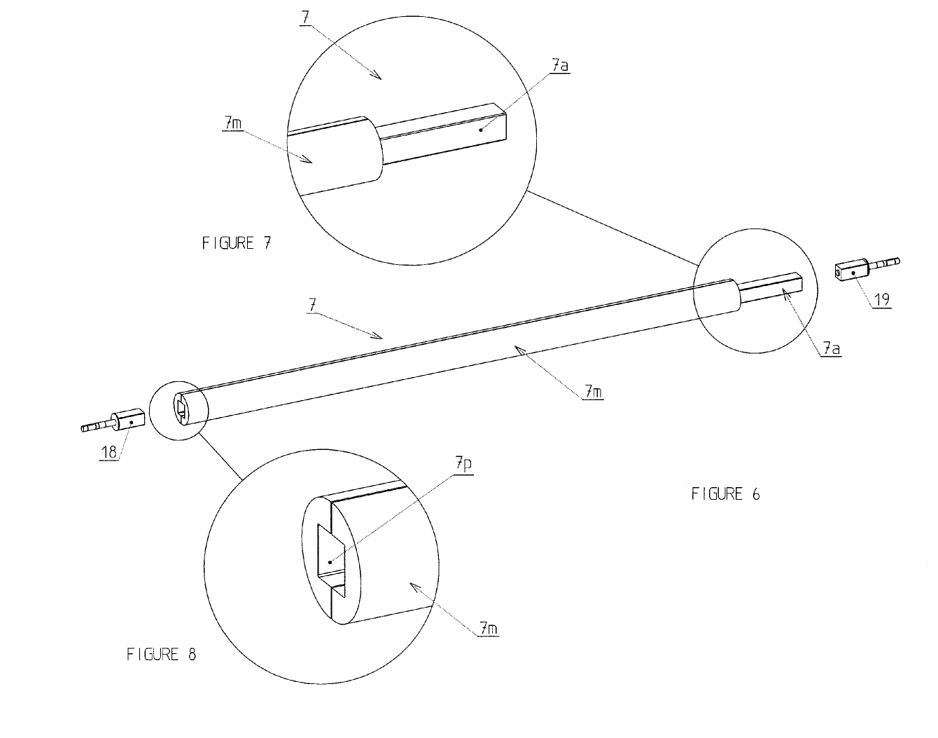

FIGS. 6 to 8 are perspective and detailed views depicting a first alternative form of the modular drum according to the present invention.

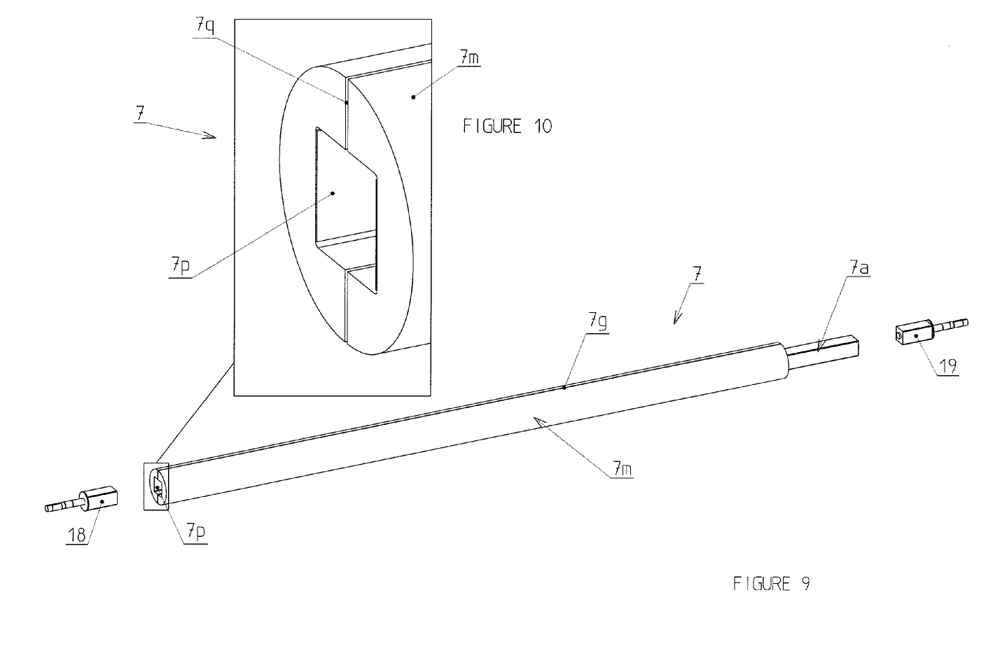

FIGS. 9 and 10 are perspective views illustrating a second alternative form of the modular drum according to the present invention.

FIG. 1 by way of example shows a goods-handling door 1 for industrial buildings, comprising two lateral and opposed uprights 2 and 3 joined together at their top by a profile section 4. The lateral uprights 2 and 3 may or may not be fixed a certain distance away from the face 5 of a wall depending on the purpose of the goods-handling door 1.

The goods-handling door 1 is, in this example, a stacking door comprising, in the horizontal box structure 4 connecting the uprights 2 and 3 together, the drive drum 7 which, via hauling straps 8, is able to move a flexible screen 6 between an open position and a closed position.

The flexible screen 6 comprises sheaths 9 each of which, in its internal part, contains horizontal reinforcing members 10.

Some sheaths 9 of the flexible screen 6 have openings 11 so that each hauling strap 8 can be connected to the corresponding horizontal member 10 via strap loops 12.

The flexible screen 6, in its lower part and inside a sheath 9, comprises a horizontal member 13 which is connected by a fixing device 14 to the hauling straps 8.

Each vertical upright 2, 3 comprises a guide device 15 capable of guiding the flexible screen 6 and the horizontal members 10, 13 during vertical movements of the said screen.

For example, the guide device 15 provided on each upright 2, 3 has either two taut straps or two semi-rigid strips 16, 17 positioned facing one another.

FIGS. 2 and 3 depict a drive drum 7 according to the present invention which is intended for all kinds of goods-handling doors 1 for moving the flexible screen 6 between an open position and a closed position.

The drive drum 7 is able to collaborate either directly with the flexible screen 6 or with the hauling straps 8 for moving the said screen, depending on the type of goods-handling door 1.

The drive drum 7 consists of a tubular profile 7a forming the central part or core of the said drum. The tubular profile 7a is made of steel or of composite and may in cross section have a square or rectangular or some other profile.

Each end of the central tubular profile 7a of the drive drum 7 collaborates firstly with the end of a drive shaft 18 connected to a gear motor unit for moving the flexible apron or screen 6 and secondly with the end of a free shaft 19 that drives a device for positioning of the flexible apron or screen 6.

The drive drum 7 consists of a shell 7m of cylindrical profile fitting around the central tubular profile 7a so that the latter has a cylindrical external profile that can be elastically deformed under external pressure.

The shell 7m of cylindrical profile is placed around the central tubular profile 7a so as to be able to be demounted, changed or modified according to the characteristics of the flexible apron or screen 6. The fact that the shell 7m of cylindrical profile can be demounted makes it possible to form what is called a “modular” drive drum 7.

For this purpose and by way of example, the shell 7m of cylindrical profile is made from two half-shells 7b, 7c made of a flexible or semirigid material that tolerates elastic deformation when subjected to external pressure.

Each half-shell 7b, 7c has an external profile 7d in the form of a portion of a cylinder and a flat and straight internal profile 7e. The internal profile 7e has a central groove 7f formed along the entire length of each half-shell 7b, 7c. The internal profile 7e has, above and below the central groove 7f and along the entire length of each half-shell 7b, 7c, faces 7g which are flat and parallel.

The central groove 7f of each half-shell 7b, 7c has a bottom 7h located in a vertical plane and parallel to the plane containing the faces 7g bordering the said groove.

The bottom 7h of the central groove 7f collaborates along its entire length with an adhesive tape 7i or the like used for fixing and holding each half-shell 7b, 7c around the tubular profile 7a.

The central groove 7f of each half-shell 7b, 7c has internal dimensions which complement the external dimensions of the tubular profile 7a. Thus, the height h of the central groove 7f is slightly greater than that of the side 7j of the tubular profile 7a while the depth p of the central groove 7f is equal to half the depth of the side 7k, positioned at right angles to the side 7j, of the tubular profile 7a.

The first and second half-shells 7b, 7c are positioned around the tubular profile 7a in such a way that each side 7j of the said tubular profile collaborates with the adhesive tape 7i or the like provided in the bottom 7h of the grooves 7f.

This arrangement allows the half-shells 7b, 7c to be assembled onto and around the tubular profile 7a in order to completely envelop it over its entire length. Thus, the modular drum 7 has a cylindrical external profile which stems from the combination of the external profiles 7d of each of the half-shells 7b, 7c so that the said cylindrical external profile can deform elastically under external pressure.

FIGS. 4 and 5 depict the modular drum 7 the tubular profile 7a of which is entirely enveloped by the first and second half-shells 7b, 7c.

It will be noted that the shell 7m and, for example at least one of the half-shells 7b, 7c has, on its external profile 7d in the form of a portion of a cylinder, fixing means 20 which can be used for fixing and holding the flexible apron or screen 6 when the goods-handling door 1 is, for example, of the roll up type.

The fixing means 20 are arranged along the entire length of the modular drum 7 and parallel to the horizontal axis thereof.

The fixing means 20 may consist of a sufficiently wide tape 21 of the VELCRO type which, on account of its characteristics, allows the flexible apron or screen 6 to be attached and detached without damage to the external profile 7d of the shell 7m or to the corresponding half-shell 7b, 7c.

FIGS. 6 to 8 illustrate a first alternative form of the modular drum 7 and, more specifically, of the shell 7m of cylindrical profile enveloping the tubular profile 7a.

The shell 7m is made in a single flexible part and at its middle and along its entire length has an internal profile 7e provided along a bore 7p the profile of which complements the external profile of the tubular profile 7a that forms the core of the modular drive drum 7.

The bore 7p is designed to collaborate with the tubular profile 7a so that the latter is completely enveloped by the shell 7m so that it has a cylindrical external profile that is also elastically deformable when subjected to external pressure.

FIGS. 9 and 10 depict a second alternative form of the modular drum 7 and, more specifically, of the shell 7m of cylindrical profile that envelopes the tubular profile 7a.

The shell 7m is made as a single flexible part and, at its middle and along its entire length, has a bore 7p of a profile that complements the external profile of the tubular profile 7a that forms the core of the modular drum 7.

The shell 7m, along its entire length and starting from its cylindrical external profile, has a slot 7q opening into the internal profile 7e provided along a bore 7p accommodating the tubular profile 7a.

The slot 7q allows access to be had in order to insert the tubular profile 7a inside the bore 7p by parting the two edges of this slot.

The slot 7q is then closed over the entire length of the shell 7m using, for example, an adhesive tape or the like.

It will be noted that the modular drive drum 7 according to the present invention is lightweight and easy to adjust to the desired length according to the characteristics of the goods-handling door 1.

It will be observed that the modular drive drum 7 according to the present invention allows the flexible apron or screen 6 or the hauling straps 8 to be wound up and unwound quietly because of the elastic deformation of the shell 7m under external pressure. This elastic deformation of the shell 7m absorbs the jolts and the resonance of the horizontal members 10, 13 of the flexible apron or screen 6.

The shell 7m can be made of various hydrophobic elastic materials such as a cellular or cross-linked foam for example. The shell 7m may equally be made of an elastic material such as an extruded polyethylene for example.

It must be pointed out that the modular drive drum 7 according to the present invention has no permanent connection such as a welded, screwed or keyed connection connecting the tubular profile 7a to the shafts 18, 19 and preventing any modification thereof to suit the characteristics of the goods-handling door 1.

It should be noted that the shell 7m can be easily demounted from the tubular profile 7a, enabling for example it to be changed if it were to become worn, without it being required to entirely dismantle the modular drive drum 7.

Furthermore, the shell 7m may be changed so as to increase or decrease its cylindrical external diameter in order for the latter to be perfectly adapted to operating conditions of the goods-handling door 1 if the characteristics of the latter were to be modified.

It must also be understood that the foregoing description is given merely by way of example and does not in any way restrict the scope of the invention and that replacing the embodiment details described with any other equivalent details would not constitute a departure from the said scope.

1. Modular drum for a goods-handling door (1) allowing a flexible apron or screen (6) or hauling straps (8) to be wound up or unwound between an open position and a closed position, characterized in that it consists of a central tubular profile (7a) made of steel or of a composite having in cross section a square or rectangular profile forming the central part or core of the said drive drum (7) and a demountable flexible shell (7m) having an external profile (7d) in the form of a portion of a cylinder and a flat and rectilinear internal profile (7e) complementary to that of the tubular profile (7a) so that the said drive drum (7) has a cylindrical external profile that can be deformed elastically under external pressure.

2. Modular drum according to claim 1, characterized in that the central tubular profile (7a) collaborates firstly with the end of a drive shaft (18) connected to a gear motor unit for moving the flexible apron or screen (6) or the hauling straps (8) and secondly with the end of a free shaft (19) that drives a device for positioning of the flexible apron or screen (6).

3. Modular drum according to claim 1, characterized in that the shell (7m) is made of an elastic, flexible or semirigid material such as extruded polyethylene.

4. Modular drum according to claim 1, characterized in that the shell (7m) is made of an elastic material such as a cellular or cross-linked foam.

5. Modular drum according to claim 1, characterized in that the shell (7m) is made of a hydrophobic elastic material.

6. Modular drum according to claim 1, characterized in that the shell (7m) is made up of two half-shells (7b, 7c) having an external profile (7d) in the form of a portion of a cylinder and a flat and straight internal profile (7e).

7. Modular drum according to claim 6, characterized in that the internal profile (7e) of each half-shell (7b, 7c) has a central groove (7f).

8. Modular drum according to claim 7, characterized in that the central groove (7f) of each half-shell (7b, 7c) has a bottom (7h) which along its entire length collaborates with an adhesive tape (7i) or the like used for fixing and holding each half-shell (7b, 7c) around the tubular profile (7a).

9. Modular drum according to claim 7, characterized in that the central groove (7f) of each half-shell (7b 7c) has a height h which is slightly greater than that of the sides (7j) of the tubular profile (7a) and a depth p which is equal to half the depth of the sides (7k), positioned at right angles to the side (7j), of the said tubular profile (7a).

10. Modular drum according to claim 1, characterized in that the internal profile (7e) of the shell (7m) is provided along a bore (7p) the profile of which complements the external profile of the tubular profile (7a).

11. Modular drum according to claim 11, characterized in that the shell (7m), along its entire length and starting from its cylindrical external profile, has a slot (7g) opening into the internal profile (7e) accommodating the tubular profile (7a).

12. Modular drum according to claim 11, characterized in that the slot (7q) provided on the shell (7m) is closed off by an adhesive tape.

13. Modular drum according to claim 1, characterized in that the shell (7m) comprises, on its external profile that is shaped as a portion of a cylinder, fixing means (20) that can be used for fitting and holding the flexible apron or screen (6).

14. Modular drum according to claim 7, characterized in that at least one of the half-shells (7b, 7c) comprises, on its external profile (7d) that is shaped as a portion of a cylinder, fixing means (20) that can be used for fitting and holding the flexible apron or screen (6).

15. Modular drum according to claim 13, characterized in that the fixing means (20) consist of a tape (21) of the VELCRO type.

16. Modular drum according to claim 14, characterized in that the fixing means (20) consist of a tape (21) of the VELCRO type.
